(19) United States
(12) Patent Application Publication
(10) Pub. No.: US 2026/0292571 A1
(43) Pub. Date: Sep. 24, 2026

(54) MEASUREMENT ACCURACY REPORTING

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US)

(21) Appl. No.: 19/473,644

(22) PCT Filed: Jun. 9, 2023
(86) PCT No.: PCT/CN2023/099309

§ 371 Date: Oct. 8, 2025

(51) Int. Cl. H04W 24/10; H04B 17/318; H04B 17/336

(52) U.S. Cl. CPC H04W 24/10; H04B 17/328; H04B 17/336

(57) ABSTRACT

Various aspects of the present disclosure generally relate to wireless communication. In some aspects, a user equipment (UE) may receive, from a network node, an indication of a Layer 1 (L1) reference signal received power (RSRP) or an L1 signal-to-interference-plus-noise ratio (SINR) measurement accuracy requirement. The UE may transmit, to the network node, an indication of an L1 RSRP or L1 SINR measurement accuracy associated with an L1 RSRP or L1 SINR reported by the UE. Numerous other aspects are described.

### FIELD OF THE DISCLOSURE

Aspects of the present disclosure generally relate to wireless communication and to techniques and apparatuses for measurement accuracy reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, an indication of a Layer 1 (L1) reference signal received power (RSRP) or an L1 signal-to-interference-plus-noise ratio (SINR) measurement accuracy requirement. The method may include transmitting, to the network node, an indication of an L1 RSRP or L1 SINR measurement accuracy associated with an L1 RSRP or L1 SINR reported by the UE.

Some aspects described herein relate to a method of wireless communication performed by a network node. The method may include transmitting, to a UE, an indication of an L1 RSRP or an L1 SINR measurement accuracy requirement. The method may include receiving, from the UE, an indication of an L1 RSRP or L1 SINR measurement accuracy associated with an L1 RSRP or L1 SINR reported by the UE.

Some aspects described herein relate to a UE for wireless communication. The UE may include one or more memories and one or more processors coupled to the one or more memories. The one or more processors may be configured to receive, from a network node, an indication of an L1 RSRP or an L1 SINR measurement accuracy requirement. The one or more processors may be configured to transmit, to the network node, an indication of an L1 RSRP or L1 SINR measurement accuracy associated with an L1 RSRP or L1 SINR reported by the UE.

Some aspects described herein relate to a network node for wireless communication. The network node may include one or more memories and one or more processors coupled to the one or more memories. The one or more processors may be configured to transmit, to a UE, an indication of an L1 RSRP or an L1 SINR measurement accuracy requirement. The one or more processors may be configured to receive, from the UE, an indication of an L1 RSRP or L1 SINR measurement accuracy associated with an L1 RSRP or L1 SINR reported by the UE.

Some aspects described herein relate to a non-transitory computer-readable medium that stores a set of instructions for wireless communication by a UE. The set of instructions, when executed by one or more processors of the UE, may cause the UE to receive, from a network node, an indication of an L1 RSRP or an L1 SINR measurement accuracy requirement. The set of instructions, when executed by one or more processors of the UE, may cause the UE to transmit, to the network node, an indication of an L1 RSRP or L1 SINR measurement accuracy associated with an L1 RSRP or L1 SINR reported by the UE.

Some aspects described herein relate to a non-transitory computer-readable medium that stores a set of instructions for wireless communication by a network node. The set of instructions, when executed by one or more processors of the network node, may cause the network node to transmit, to a UE, an indication of an L1 RSRP or an L1 SINR measurement accuracy requirement. The set of instructions, when executed by one or more processors of the network node, may cause the network node to receive, from the UE, an indication of an L1 RSRP or L1 SINR measurement accuracy associated with an L1 RSRP or L1 SINR reported by the UE.

Some aspects described herein relate to an apparatus for wireless communication. The apparatus may include means for receiving, from a network node, an indication of an L1 RSRP or an L1 SINR measurement accuracy requirement. The apparatus may include means for transmitting, to the network node, an indication of an L1 RSRP or L1 SINR measurement accuracy associated with an L1 RSRP or L1 SINR reported by the UE.

Some aspects described herein relate to an apparatus for wireless communication. The apparatus may include means for transmitting, to a UE, an indication of an L1 RSRP or an L1 SINR measurement accuracy requirement. The apparatus may include means for receiving, from the UE, an indication of an L1 RSRP or L1 SINR measurement accuracy associated with an L1 RSRP or L1 SINR reported by the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of artificial intelligence and machine learning based beam management, in accordance with the present disclosure.

FIG. 5 is a diagram illustrating an example of measurement accuracy reporting, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

A user equipment (UE) may be configured to report one or more measurements to a network node. For example, the UE may report a reference signal received power (RSRP) measurement and/or a signal-to-interference-plus-noise ratio (SINR) measurement to the network node. The network node may use the RSRP measurement and/or the SINR measurement for beam prediction. The beam prediction performed at the network node may be limited by the accuracy of the measurements reported by the UE. For example, an accuracy of a beam prediction performed at the network node may be limited by a Layer 1 (L1) RSRP or L1 SINR measurement accuracy received from the UE in an L1 report. The UE-reported L1 RSRP or L1 SINR may be used as an input (e.g., the primary input) in a network node model for beam prediction. In some cases, an acceptable measurement error for the L1 RSRP may be ±10 decibels (dB). Training the model using inaccurately measured L1 RSRP or L1 SINR values may result in degraded beam prediction performance by the network node.

Various aspects relate generally to wireless communication. Some aspects more specifically relate to measurement accuracy requirement signaling for L1 RSRP and L1 SINR measurements. In some examples, a network node may transmit, and a UE may receive, an indication of an L1 RSRP or an L1 SINR measurement accuracy requirement. The UE may transmit, and the network node may receive, an indication of an L1 RSRP or L1 SINR measurement accuracy associated with an L1 RSRP or L1 SINR reported by the UE. The L1 RSRP or L1 SINR measurement accuracy requirement may be based at least in part on the L1 RSRP or L1 SINR measurement accuracy transmitted by the UE, or may be independent of the L1 RSRP or L1 SINR measurement accuracy transmitted by the UE. Additionally, or alternatively, the L1 RSRP or L1 SINR measurement accuracy transmitted by the UE may be based at least in part on the L1 RSRP or L1 SINR measurement accuracy requirement, or may be independent from the L1 RSRP or L1 SINR measurement accuracy requirement. The L1 RSRP or L1 SINR measurement accuracy requirement may be transmitted to the UE via an L1 report or a higher-layer protocol message. Additionally, or alternatively, the indication of the L1 RSRP or L1 SINR measurement accuracy may be transmitted by the UE via an L1 report or a higher-layer protocol message. In some examples, the L1 RSRP or L1 SINR measurement accuracy requirement may be based at least in part on an absolute accuracy or a relative accuracy associated with an L1 RSRP or L1 SINR to be reported by the UE, and the L1 RSRP or L1 SINR measurement accuracy associated with the L1 RSRP or L1 SINR reported by the UE may be based at least in part on the absolute accuracy or the relative accuracy associated with the L1 RSRP or L1 SINR reported by the UE. In some cases, depending on different network-node-side implementation details, the measurement accuracy requirement may be in accordance with a plurality of levels. For example, when the network node is able to use complex artificial intelligence (AI) or machine learning (ML) models to minimize prediction errors for measured RSRP measurements, the measurement accuracy requirement may be more relaxed. Alternatively, when the network node is not able to use complex AI/ML models to minimize the prediction errors, the measurement accuracy requirement may be stricter. In some cases, not all L1 reports are to be used at the network node for beam prediction inference or data-collection, while meeting stricter L1 RSRP or L1 SINR measurement accuracy requirements may result in higher UE power consumption (e.g., more advanced filtering algorithms and/or more panels, antenna-elements, and phase-shifters, among other examples, may need to be used).

Particular aspects of the subject matter described in this disclosure can be implemented to realize one or more of the following potential advantages. In some examples, a network node may determine a measurement accuracy requirement, for example, in accordance with an ability of a network-side model to minimize prediction errors for L1 RSRP and L1 SINR measurements. Additionally, or alternatively, a UE may transmit a measurement accuracy associated with an L1 RSRP and L1 SINR measurement reported by the UE. The UE may adjust one or more measurement capabilities of the UE in accordance with the measurement accuracy requirement. Additionally, or alternatively, the network node may use the measurement accuracy associated with the L1 RSRP and L1 SINR measurements reported by the UE for determining the measurement accuracy requirement. This may enable improved measurement accuracy and beam prediction by the UE and the network node. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

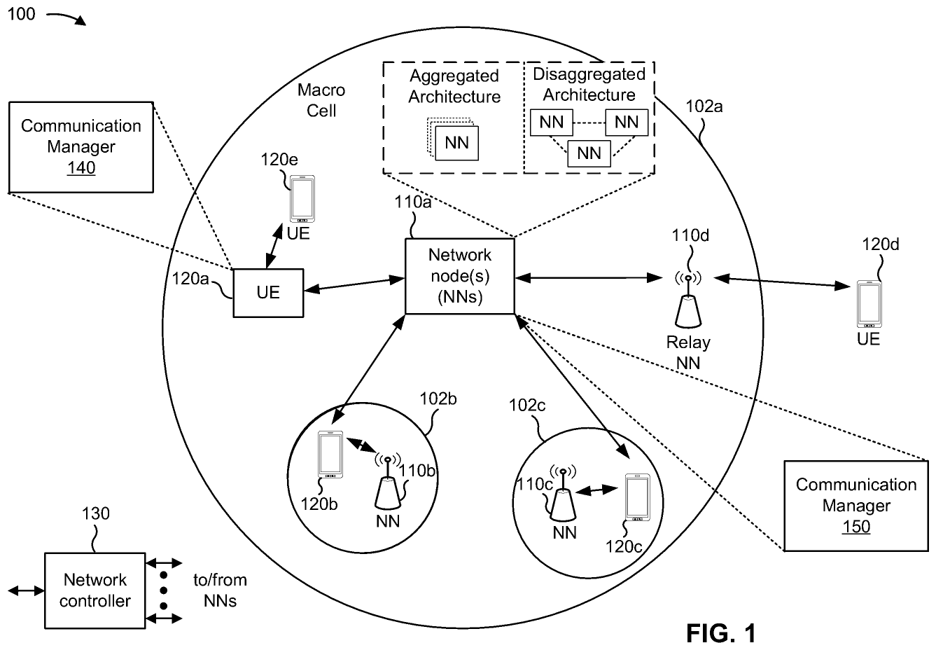

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, an indication of an L1 RSRP or an L1 SINR measurement accuracy requirement; and transmit, to the network node, an indication of an L1 RSRP or L1 SINR measurement accuracy associated with an L1 RSRP or L1 SINR reported by the UE. Additionally, or alternatively, the communication manager 140 may perform one or more other operations described herein.

In some aspects, the network node 110 may include a communication manager 150. As described in more detail elsewhere herein, the communication manager 150 may transmit, to a UE, an indication of an L1 RSRP or an L1 SINR measurement accuracy requirement; and receive, from the UE, an indication of an L1 RSRP or L1 SINR measurement accuracy associated with an L1 RSRP or L1 SINR reported by the UE. Additionally, or alternatively, the communication manager 150 may perform one or more other operations described herein.

As indicated above, FIG. 1 is provided as an example. Other examples may differ from what is described with regard to FIG. 1.

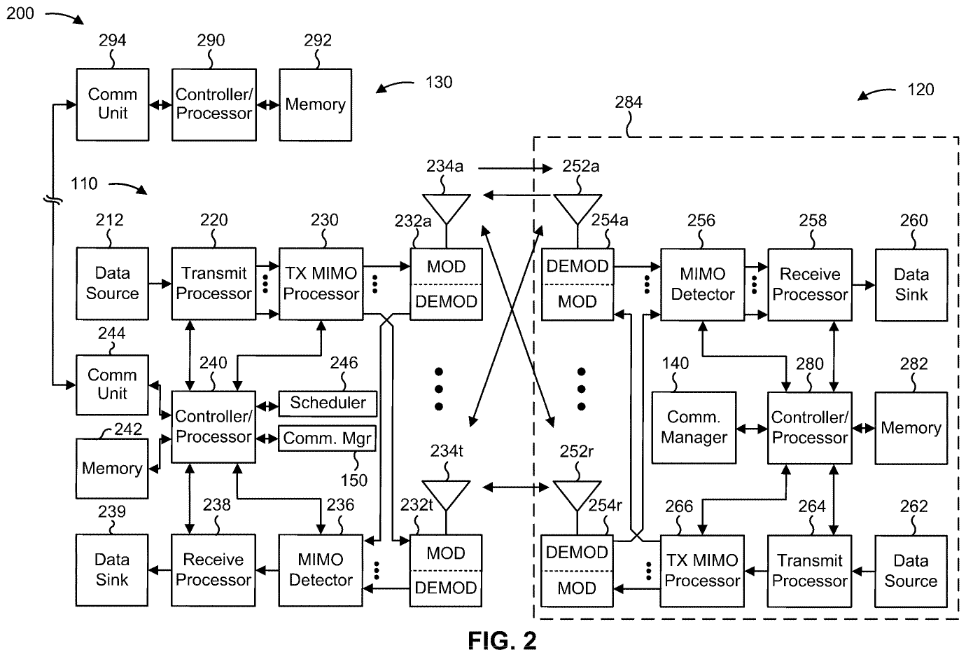

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

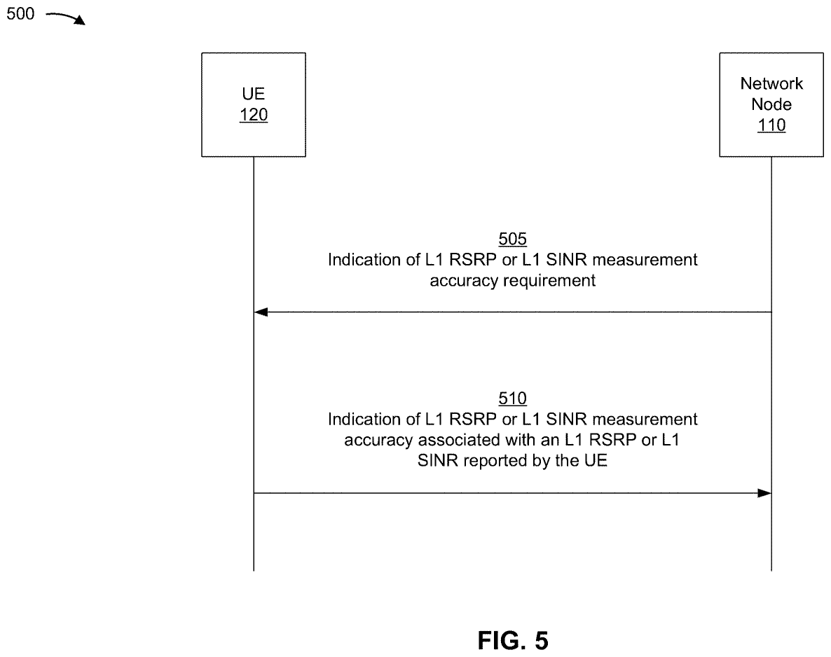

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

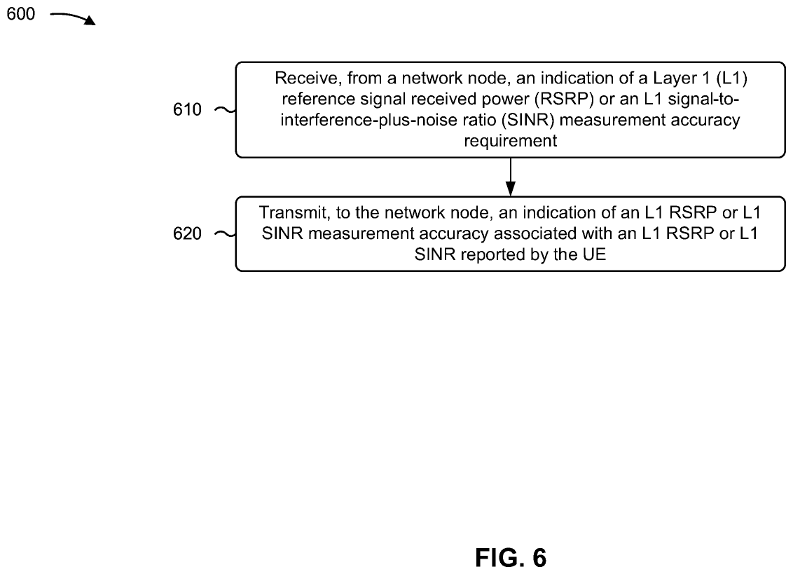

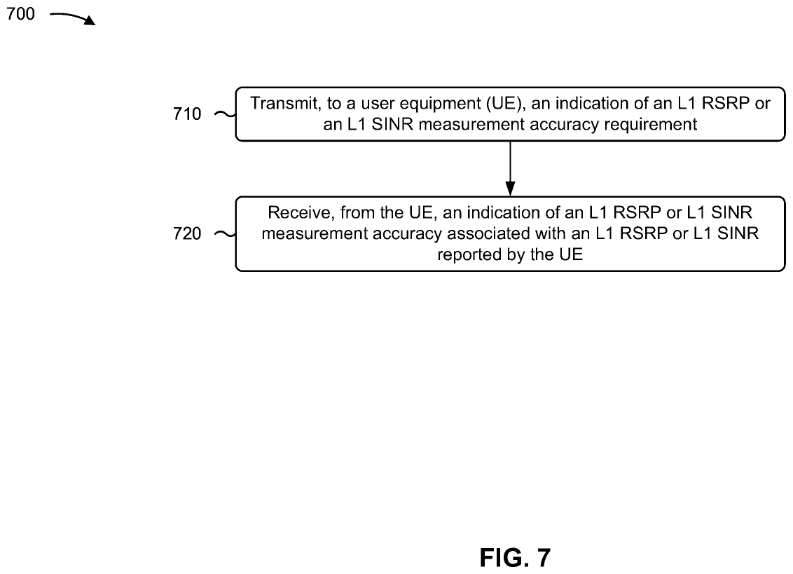

The controller/processor 240 of the network node 110, the controller/processor 280 of the UE 120, and/or any other component(s) of FIG. 2 may perform one or more techniques associated with measurement accuracy reporting, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving, from a network node, an indication of an L1 RSRP or an L1 SINR measurement accuracy requirement; and/or means for transmitting, to the network node, an indication of an L1 RSRP or L1 SINR measurement accuracy associated with an L1 RSRP or L1 SINR reported by the UE. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, an indication of an L1 RSRP or an L1 SINR measurement accuracy requirement; and/or means for receiving, from the UE, an indication of an L1 RSRP or L1 SINR measurement accuracy associated with an L1 RSRP or L1 SINR reported by the UE. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

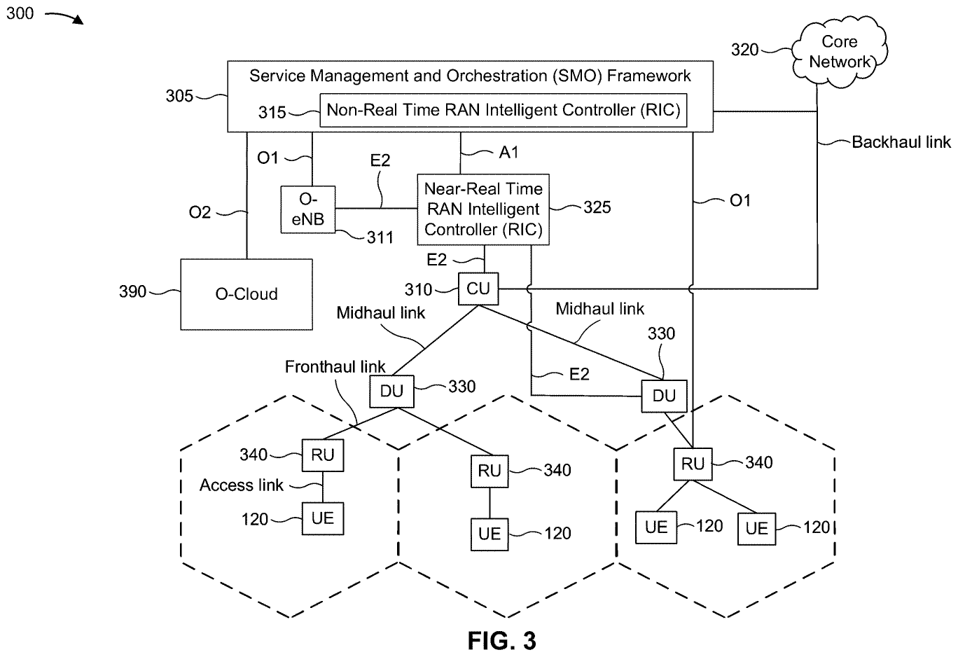

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

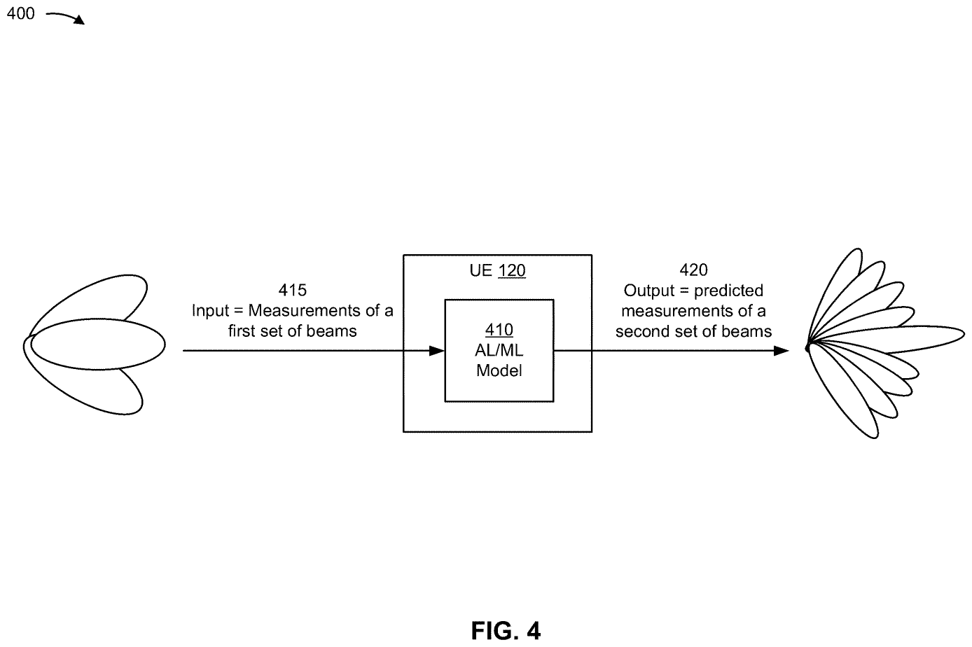

FIG. 4 is a diagram illustrating an example 400 of an AI/ML based beam management, in accordance with the present disclosure. As shown in FIG. 4, an AI/ML model 410 may be deployed at or on a UE 120. For example, a model inference host (such as a model inference host) may be deployed at, or on, a UE 120. The AI/ML model 410 may enable the UE 120 to determine one or more inferences or predictions based on data input to the AI/ML model 410.

For example, as shown by reference number 415, an input to the AI/ML model 410 may include measurements associated with a first set of beams. For example, a network node 110 may transmit one or more signals using respective beams from the first set of beams. The UE 120 may perform measurements (e.g., Layer 1 (L1) RSRP measurements or L1 SINR measurements, among other examples) of the first set of beams to obtain a first set of measurements. For example, each beam, from the first set of beams, may be associated with one or more measurements performed by the UE 120. The UE 120 may input the first set of measurements (e.g., L1 RSRP measurement values or L1 SINR measurement values) into the AI/ML model 410 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 420, the AI/ML model 410 may output one or more predictions. The one or more predictions may include predicted measurement values (e.g., predicted L1 RSRP measurement values and/or predicted L1 SINR measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 410 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 410. This may enable the AI/ML model 410 to output codebook based and/or non-codebook based predictions for a measurement value, an AoD, and/or an AoA, among other examples, of a beam at a future time. The output(s) of the AI/ML model 410, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 410 may perform spatial-domain downlink beam predictions for beams included in the Set A beams based on measurement results of beams included in the Set B beams. As another example, the AI/ML model 410 may perform temporal downlink beam prediction for beams included in the Set A beams based on historic measurement results of beams included in the Set B beams.

Accuracy requirements may be identified for RSRP and SINR measurements. For example, synchronization-signal-block (SSB)-based L1 RSRP absolute accuracy requirements in frequency range 2 (FR2) are defined in Table 10.1.20.1.1-1 of 3GPP Technical Specification (TS) 38.133 Version 17.6.0 Release 17. Example SSB-based L1 RSRP relative accuracy requirements in FR2 are defined in Table 10.1.20.1.2-1 of 3GPP TS 38.133 Version 17.6.0 Release 17. Example channel state information (CSI) reference signal (RS) (CSI-RS)-based L1 RSRP absolute accuracy requirements in FR2 are defined in Table 10.1.20.2.1-1 of 3GPP TS 38.133 Version 17.6.0 Release 17. Example CSI-RS-based L1 RSRP relative accuracy requirements in FR2 are defined in Table 10.1.20.2.2-1 of 3GPP TS 38.133 Version 17.6.0 Release 17. Example CSI-RS-based L1 SINR absolute accuracy requirements in FR2 are defined in Table 10.1.28.1.1-1 of 3GPP TS 38.133 Version 17.6.0 Release 17. Example CSI-RS-based L1 SINR relative accuracy requirements in FR2 are defined in Table 10.1.28.2.1-1 of 3GPP TS 38.133 Version 17.6.0 Release 17. Example conditions for SSB-based L1 RSRP measurements in FR2 are defined in Table B.2.4.1-2 of 3GPP TS 38.533 Version 16.8.0 Release 16. In some cases, an absolute accuracy tolerance may be defined as a limit on a measured RSRP (RSRPₘₑₐₛ) minus an ideal RSRP (RSRP_{ideal}) (RSRPₘₑₐₛ−RSRP_{ideal}). In some cases, a relative accuracy requirement may be defined as a limit on the following:

$$( {RSRP}_{meas}^{( 1 )} - {RSRP}_{meas}^{( max )} ) - ( {RSRP}_{ideal}^{( 1 )} - {RSRP}_{ideal}^{( max )} ) ,$$

where

$$\{ {RSRP}_{meas}^{( 1 )} , {RSRP}_{ideal}^{( 1 )} \}$$

are the measured and ideal L1-RSRP measurements (respectively) of a certain SSB,

$${RSRP}_{meas}^{( max )}$$

is the strongest measured L1-RSRP of all SSBs in the same serving cell (ServCell), and

$${RSRP}_{ideal}^{( max )}$$

is the ideal L1-RSRP of the strongest measured SSB.

As indicated above, FIG. 4 is provided as an example. Other examples may differ from what is described with regard to FIG. 4.

FIG. 5 is a diagram illustrating an example 500 of measurement accuracy reporting, in accordance with the present disclosure.

As shown by reference number 505, the network node 110 may transmit, and the UE 120 may receive, an indication of an L1 RSRP or L1 SINR measurement accuracy requirement. In some aspects, the L1 RSRP or L1 SINR measurement accuracy requirement may be based at least in part on an L1 RSRP or L1 SINR measurement accuracy associated with an L1 RSRP or L1 SINR reported by the UE 120. For example, the network node 110 may receive a measurement accuracy from the UE 120 associated with one or more previous L1 RSRP or L1 SINR measurements, and may determine the measurement accuracy requirement for future L1 RSRP or L1 SINR measurements based at least in part on the one or more previous L1 RSRP or L1 SINR measurements. In some other aspects, the L1 RSRP or L1 SINR measurement accuracy requirement may be independent of the L1 RSRP or L1 SINR measurement accuracy associated with the L1 RSRP or L1 SINR reported by the UE 120. For example, the network node 110 may (or may not) receive a measurement accuracy from the UE 120 associated with one or more previous L1 RSRP or L1 SINR measurements, but may determine the measurement accuracy requirement for future L1 RSRP or L1 SINR measurements based at least in part on one or more other inputs that do not include the one or more previous L1 RSRP or L1 SINR measurements. The indication of the L1 RSRP or L1 SINR measurement accuracy requirement may be communicated via an L1 report or via higher-layer signaling (such as radio resource control (RRC) signaling or user-plane signaling).

As shown by reference number 510, the UE 120 may transmit, and the network node 110 may receive, an indication of an L1 RSRP or L1 SINR measurement accuracy associated with an L1 RSRP or L1 SINR reported by the UE. For example, the UE 120 may transmit the indication of the L1 RSRP or L1 SINR measurement accuracy after receiving the indication of the L1 RSRP or L1 SINR measurement accuracy requirement in connection with reference number 505 and determining the L1 RSRP or L1 SINR measurement accuracy. In some aspects, the L1 RSRP or L1 SINR measurement accuracy may be based at least in part on the L1 RSRP or L1 SINR measurement accuracy requirement received from the network node 110. For example, the UE 120 may perform L1 RSRP or L1 SINR measurements that meet or exceed an accuracy level that satisfies the measurement accuracy requirement received from the network node 110. In some other aspects, the L1 RSRP or L1 SINR measurement accuracy may be independent of the L1 RSRP or L1 SINR measurement accuracy requirement received from the network node 110. For example, the UE 120 may perform L1 RSRP or L1 SINR measurements that meet or exceed an accuracy level, where the accuracy level is based at least in part on factors that do not include the measurement accuracy requirement received from the network node 110, such as a capability of the UE. In some aspects, transmitting the L1 RSRP or L1 SINR measurements may include transmitting an L1 report or higher-layer signaling (such as RRC signaling or user-plane signaling) that includes the L1 RSRP or L1 SINR measurements.

In some aspects, the indication of the L1 RSRP or L1 SINR measurement accuracy requirement transmitted by the network node 110 in connection with reference number 505 and/or the indication of the L1 RSRP or L1 SINR measurement accuracy transmitted by the UE 120 in connection with reference number 510 may be based at least in part on an absolute accuracy and/or a relative accuracy. In some aspects, an absolute accuracy tolerance may be defined a limit on:

RSRP_{predict}−RSRP_{reference}.

In some aspects, a relative accuracy tolerance may be defined as a limit on:

$$( {RSRP}_{predict}^{( 1 )} - {RSRP}_{predict}^{( max )} ) - ( {RSRP}_{reference}^{( 1 )} - {RSRP}_{reference}^{( max )} ) ,$$

where

$$\{ {RSRP}_{predict}^{( 1 )} , {RSRP}_{reference}^{( 1 )} \}$$

are the predicted & reference L1-RSRPs of a certain resource,

$${RSRP}_{predict}^{( max )}$$

is the strongest predicted L1-RSRP of all the prediction target resources, and

$${RSRP}_{ideal}^{( max )}$$

is the reference L1-RSRP of that strongest predicted target resource.

The absolute accuracy and the relative accuracy may be separately identified for the L1 RSRP or L1 SINR measurement accuracy requirement transmitted by the network node 110 and the L1 RSRP or L1 SINR measurement accuracy transmitted by the UE 120. In one example, the network node 110 may transmit an indication of a required absolute accuracy of ±5 dB and an indication of a required relative accuracy of ±3 dB. In another example, the UE 12-may transmit an indication of an achieved absolute accuracy of ±5 dB and an indication of an achieved relative accuracy of ±3 dB. In some aspects, the absolute accuracy and the relative accuracy may be separately identified for L1 RSRP and L1 SINR. Additionally, or alternatively, the absolute accuracy and the relative accuracy may be separately identified for SSBs or CSI-RSs.

In some aspects, the UE 120 may obtain an indication of multiple L1 RSRP or L1 SINR accuracy requirement levels and associated accuracy requirements. The indicated multiple L1 RSRP or L1 SINR accuracy requirement levels and associated accuracy requirements may be separately defined for absolute and relative accuracies, and/or may be separately defined for SSBs and CSI-RSs. In some aspects, the network node 110 may transmit an indication of a required L1 RSRP or L1 SINR accuracy level to be used by the UE 120. For example, the network node may transmit user-plane signaling, a radio resource control (RRC) message, a medium access control (MAC) control element (CE) (MAC-CE), or downlink control information (DCI) that includes an accuracy level identifier associated with a required L1 RSRP or L1 SINR accuracy level to be used by the UE 120. In one example, the network node 110 may transmit user-plane signaling, associated with collecting L1 RSRP and L1 SINR measurements, that includes the accuracy level identifier. The user-plane signaling that includes the accuracy level identifier may be signaled separately for absolute and relative accuracy level identifiers. In another example, the network node 110 may transmit RRC configuration information, associated with collecting L1 RSRP and L1 SINR feedback via RRC messages, that includes the accuracy level identifier. The RRC configuration information that includes the accuracy level identifier may be signaled separately for absolute and relative accuracy level identifiers. In another example, the network node 110 may transmit RRC configuration information, associated with a CSI report setting for an L1 report that includes L1 RSRP and L1 SINR measurements as a report quantity (e.g., a reportQuantity information element or field), that includes the accuracy level identifier. The RRC configuration information that includes the accuracy level identifier may be signaled separately for absolute and relative accuracy level identifiers. In another example, the network node 110 may transmit RRC configuration information, associated with CSI-associated report configuration information (e.g., a CSI-AssociatedReportConfigurationInfo information element or field) with respect to an access point (AP) CSI report setting that includes L1 RSRP and L1 SINR measurements as a report quantity (e.g., a reportQuantity information element or field), that includes the accuracy level identifier. The RRC configuration information that includes the accuracy level identifier may be signaled separately for configured absolute and relative accuracy level identifiers. In another example, the network node 110 may transmit a MAC-CE, that activates a semi-persistent (SP) CSI report that includes L1 RSRP and L1 SINR measurements as a report quantity (e.g., a reportQuantity information element or field), that includes the accuracy level identifier. The MAC-CE that includes the accuracy level identifier may be signaled separately for absolute and relative accuracy level identifiers. In another example, the network node 110 may transmit DCI, that triggers a CSI report that includes L1 RSRP and L1 SINR measurements as a report quantity (e.g., a reportQuantity information element or field), that includes one or more dedicated DCI fields that indicate the accuracy level (or accuracy level identifier) to be applied to all L1 reports triggered by the DCI. The DCI may be in accordance with separately indicated absolute and relative accuracy level identifiers, and/or in accordance with separately indicated accuracy level identifiers for L1 RSRP reports and L1 SINR reports.

In some aspects, the network node 110 may transmit the accuracy requirement in accordance with one or more UE capabilities. For example, the UE 120 may transmit, and the network node 110 may receive, RRC information or user-plane signaling that indicates one or more UE capabilities with respect to L1 RSRP or L1 SINR accuracy level identifiers that are capable of being supported by the UE 120 and the network node 110 may transmit accuracy requirements that the UE 120 can meet. In some aspects, the UE capabilities may be separately reported for absolute and relative accuracies, and/or may be separately reported for SSBs and CSI-RSs. For example, a first UE capability may be reported for an absolute accuracy and a second UE capability may be reported for a relative accuracy, and/or a third UE capability may be reported for an SSB and a fourth UE capability may be reported for CSI-RS. The L1 RSRP or L1 SINR accuracy requirement received from the network node 110 may not exceed (e.g., be stricter than) the accuracy levels indicated in the UE capability information.

In some aspects, the UE 120 may be configured to satisfy the accuracy requirements configured or indicated by the network node 110. For example, the UE 120 may be configured to always satisfy accuracy requirements when performing L1 RSRP or L1 SINR measurements or to satisfy the accuracy requirements for a subset of L1 RSRP or L1 SINR measurements. In some other aspects, the UE 120 may not be able to satisfy the accuracy requirements configured or indicated by the network node 110. In one example, if the UE 120 does not satisfy the configured or indicated accuracy requirements when performing L1 RSRP or L1 SINR measurements, the UE 120 may transmit an indication to the network node 110 indicating that the UE 120 is not able to satisfy the configured or indicated accuracy requirements. For example, a dedicated field included in an L1 report may be used for reporting the indication that the UE 120 is not able to satisfy an accuracy requirement. As a specific example, the dedicated field may be used to indicate that a single L1 RSRP or L1 SINR does not satisfy the accuracy requirement, to indicate that a certain number of L1 RSRP or L1 SINR requirements do not satisfy the accuracy requirement (e.g., the strongest K, where K is the number of L1 RSRP or L1 SINR requirements that do not satisfy the accuracy requirement, and is configured or indicated by the network node 110), or to indicate whether each respective L1 RSRP or L1 SINR included in the L1 report satisfies or does not satisfy the accuracy requirement. Alternatively, the indication that the UE 120 is not able to satisfy the accuracy requirement may be included in a MAC-CE that includes the associated L1 report slot identifiers and/or associated SSB or CSI-RS identifiers. Alternatively, the indication that the UE 120 is not able to satisfy the accuracy requirement may be included in a same RRC message that is used for reporting L1 RSRP or L1 SINR measurements, where the L1 RSRP and L1 SINR are feedback RRC messages. In another example, in accordance with the UE 120 not satisfying the configured or indicated accuracy requirements, the UE 120 may indicate an accuracy level that is achieved by the UE 120 (e.g., with or without transmitting an indication that the UE 120 is not able to satisfy the configured or indicated accuracy requirement). For example, the UE 120 may transmit a MAC-CE that includes an L1 report slot identifier and/or associated SSB or CSI-RS identifiers in accordance with an event being triggered, where a triggering condition for the event is the accuracy requirement indicated by the network node 110 not being satisfied. In another example, in accordance with the UE 120 not satisfying the configured or indicated accuracy requirements, the UE 120 may drop the corresponding L1 RSRP or L1 SINR measurements. For example, in user-plane-based data collection, the UE 120 may exclude the L1 RSRP or L1 SINR measurements having accuracy levels that do not satisfy the configured or indicated accuracy requirements.

In some aspects, the UE 120 may transmit an indication of an accuracy level that is achieved by the UE 120. The UE 120 may transmit the indication of the accuracy level that is achieved by the UE 120 in accordance with the measurement accuracy requirement received from the network node 110 or independent from the measurement accuracy requirement received from the network node 110. In one example, the UE 120 may obtain an indication of multiple accuracy levels and associated accuracy requirements, and may transmit, to the network node 110, an indication of an accuracy level of the multiple of accuracy levels that is achieved by the UE 120. As a specific example, if the UE 120 is not capable of achieving an accuracy level that satisfies the measurement accuracy requirement, then the UE 120 may transmit an indication of the highest accuracy level that the UE 120 can achieve. In some aspects, the indication of the accuracy level may be in accordance with separately defined absolute and relative accuracy levels, and/or in accordance with separately defined SSBs and CSI-RSs.

In some aspects, the UE 120 may transmit user-plane signaling, an RRC message, a MAC-CE, or DCI that includes the accuracy level identifier associated with the achieved L1 RSRP or L1 SINR measurement accuracy. In one example, the UE 120 may transmit user-plane signaling, associated with collecting L1 RSRP and L1 SINR measurements, that includes an indication of the accuracy level identifier. The user-plane signaling that includes the accuracy level identifier may be signaled separately for absolute and relative accuracy level identifiers. In another example, the UE 120 may transmit RRC configuration information, associated with collecting L1 RSRP or L1 SINR feedback via RRC messages, that includes the accuracy level identifier. The RRC configuration information that includes the accuracy level identifier may be signaled separately for absolute and relative accuracy level identifiers. In another example, the UE 120 may transmit a CSI report that includes L1 RSRP or L1 SINR measurements as a report quantity (e.g., a reportQuantity information element or field) and that includes an indication of the accuracy level identifier. The CSI report that includes the accuracy level identifier may be signaled separately for absolute and relative accuracy level identifiers. The CSI report may indicate an average accuracy level across all reported L1 RSRP and L1 SINR measurements, or may indicate respective accuracy levels that are achieved for respective L1 RSRP and L1 SINR measurements. In another example, the UE 120 may transmit a MAC-CE, associated with a report setting identifier, that indicates an achieved accuracy level identifier for past L1 RSRP or L1 SINR measurements after the CSI report was activated and/or after a transmission of a previous MAC-CE. The MAC-CE that includes the accuracy level identifier may be signaled separately for absolute and relative accuracy level identifiers.

In some aspects, the UE 120 may transmit an indication of an L1 RSRP or L1 SINR accuracy for network-trained models inferenced at the UE 120. The UE 120 may obtain an indication of multiple L1 RSRP or L1 SINR accuracy requirement levels and associated accuracy requirements, and may transmit an indication of an L1 RSRP or L1 SINR accuracy level that corresponds to one of the multiple L1 RSRP or L1 SINR accuracy requirement levels. In some aspects, the L1 RSRP or L1 SINR for the network-trained models inferenced at the UE 120 may be separately defined for absolute and relative accuracies, and/or may be separately defined for SSBs and CSI-RSs. For example, a first L1 RSRP or L1 SINR may be defined for an absolute accuracy and a second L1 RSRP or L1 SINR may be defined for a relative accuracy, and/or a third L1 RSRP or L1 SINR may be defined for SSB and a fourth L1 RSRP or L1 SINR may be defined for CSI-RS.

In some aspects, the UE 120 may receive an indication from the network node 110 to use an AI/ML model for predicting beam characteristics (e.g., where the AI/ML model) is downloaded from the network. In some aspects, an input to the AI/ML model may include L1 RSRP or L1 SINR measurements performed by the UE 120 using SSBs or CSI-RSs. In accordance with the UE 120 receiving the indication to use an AI/ML model, the UE 120 may receive, from the network node, information associated with one or more L1 RSRP or L1 SINR measurement accuracy level identifiers to be used for performing inferenced-based measurements using the AI/ML model. In one example, the information may be included in protocol information associated with the UE 120 downloading the AI/ML model. In another example, the information may be RRC configured by a CSI report setting linked with the AI/ML model identifier. In another example, the information may be included in CSI associated report configuration information (e.g., a CSI-AssociatedReportConfigInfo information element or field) linked with the AI/ML model identifier. In another example, the information may be indicated by a MAC-CE that activates a CSI report having a CSI report setting that is linked with the AI/ML model identifier.

In some aspects, the UE 120 may satisfy the network-indicated accuracy requirement when running the inference-based measurements using the AI/ML model. For example, the UE 120 may always satisfy the network-indicated requirement or may satisfy the network-indicated requirement for a subset of the inference-based measurements. In some other aspects, in accordance with the UE 120 not being able to satisfy the network-indicated requirement when running the inference-based measurements using the AI/ML model, the UE 120 may transmit, to the network node 110, an indication that the UE 120 is not able to satisfy the network-indicated requirement. In one example, the UE 120 may report predicted beam characteristics and may transmit feedback to the network node 110 (e.g., via a MAC-CE or uplink control information (UCI)) indicating that the currently reported predicted beam characteristics are based at least in part on a measurement accuracy that does not satisfy the network-required accuracy. Additionally, or alternatively, the UE 120 may transmit feedback that includes an accuracy level identifier associated with a measurement accuracy that is satisfied by the UE 120.

In some aspects, the L1 RSRP or L1 SINR measurement accuracy levels may be in accordance with a power saving mode of the UE 120. For example, different L1 RSRP or L1 SINR measurement accuracy levels may be implicitly agreed between the network node 110 and the UE 120 in accordance with a configured power saving mode of the UE 120. In one example, in accordance with a discontinuous reception (DRX) cycle of the UE 120, the candidate L1 RSRP or L1 SINR measurement accuracy level(s) may be implicitly agreed between the network node 110 and the UE 120 in accordance with a subset of all candidate L1 RSRP or SINR measurement accuracy levels. Additional configurations or indications by the network node 110, or UE reporting associated with the accuracy levels, may be in accordance with the subset of candidate L1 RSRP or SINR measurement accuracy levels. In another example, a connection between a DRX cycle value and the subset of the candidate L1 RSRP or SINR measurement accuracy levels may be defined (e.g., in a standard), configured to the UE 120 by the network node 110, or reported by the UE 120 to the network node 110 (e.g., as UE capability information during an initial access process).

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with measurement accuracy reporting.

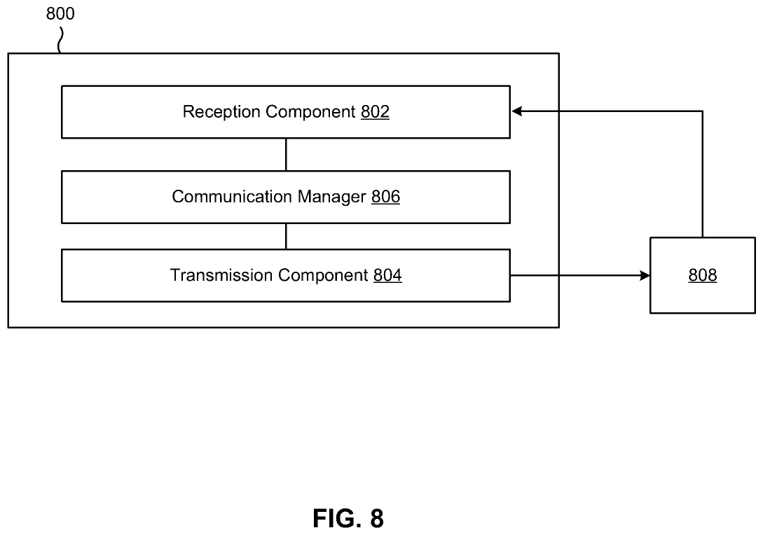

As shown in FIG. 6, in some aspects, process 600 may include receiving, from a network node, an indication of an L1 RSRP or an L1 SINR measurement accuracy requirement (block 610). For example, the UE (e.g., using reception component 802 and/or communication manager 806, depicted in FIG. 8) may receive, from a network node, an indication of an L1 RSRP or an L1 SINR measurement accuracy requirement, as described above. In some aspects, the UE may receive the indication of the L1 RSRP or the L1 SINR measurement accuracy requirement in a similar manner as described in connection with reference number 505 shown in FIG. 5.

As further shown in FIG. 6, in some aspects, process 600 may include transmitting, to the network node, an indication of an L1 RSRP or L1 SINR measurement accuracy associated with an L1 RSRP or L1 SINR reported by the UE (block 620). For example, the UE (e.g., using transmission component 804 and/or communication manager 806, depicted in FIG. 8) may transmit, to the network node, an indication of an L1 RSRP or L1 SINR measurement accuracy associated with an L1 RSRP or L1 SINR reported by the UE, as described above. In some aspects, the UE may transmit the indication of the L1 RSRP or the L1 SINR measurement accuracy in a similar manner as described in connection with reference number 510 shown in FIG. 5.

Process 600 may include additional aspects, such as any single aspect or any combination of aspects described below and/or in connection with one or more other processes described elsewhere herein.

In a first aspect, the L1 RSRP or L1 SINR measurement accuracy requirement is based at least in part on the L1 RSRP or L1 SINR measurement accuracy indication transmitted by the UE (e.g., as described in connection with FIG. 5).

In a second aspect, alone or in combination with the first aspect, the L1 RSRP or L1 SINR measurement accuracy indication transmitted by the UE is based at least in part on the L1 RSRP or L1 SINR measurement accuracy requirement (e.g., as described in connection with FIG. 5).

In a third aspect, alone or in combination with one or more of the first and second aspects, the L1 RSRP or L1 SINR measurement accuracy requirement is associated with an L1 RSRP or L1 SINR to be reported by the UE via an L1 report or a higher-layer protocol message, and transmitting the indication of the L1 RSRP or L1 SINR measurement accuracy comprises transmitting an L1 report or a higher-layer protocol message that includes the indication of the L1 RSRP or L1 SINR measurement accuracy (e.g., as described in connection with FIG. 5).

In a fourth aspect, alone or in combination with one or more of the first through third aspects, the L1 RSRP or L1 SINR measurement accuracy requirement is based at least in part on an absolute accuracy or a relative accuracy associated with an L1 RSRP or L1 SINR to be reported by the UE, and the L1 RSRP or L1 SINR measurement accuracy associated with the L1 RSRP or L1 SINR reported by the UE is based at least in part on the absolute accuracy or the relative accuracy associated with the L1 RSRP or L1 SINR reported by the UE (e.g., as described in connection with FIG. 5).

In a fifth aspect, alone or in combination with one or more of the first through fourth aspects, a plurality of absolute accuracies or relative accuracies are identified for one or more respective L1 RSRP measurements, L1 SINR measurements, synchronization signal blocks, or channel state information reference signals (e.g., as described in connection with FIG. 5).

In a sixth aspect, alone or in combination with one or more of the first through fifth aspects, process 600 includes identifying a plurality of L1 RSRP or L1 SINR measurement accuracy requirements, wherein the L1 RSRP or L1 SINR measurement accuracy requirement is a select L1 RSRP or L1 SINR measurement accuracy requirement of the plurality of L1 RSRP or L1 SINR measurement accuracy requirements (e.g., as described in connection with FIG. 5).

In a seventh aspect, alone or in combination with one or more of the first through sixth aspects, process 600 includes receiving, from the network node, user-plane signaling, a radio resource control message, a medium access control message, or downlink control information that indicates the plurality of L1 RSRP or L1 SINR measurement accuracy requirements or an identifier associated with the select L1 RSRP or L1 SINR measurement accuracy requirement (e.g., as described in connection with FIG. 5).

In an eighth aspect, alone or in combination with one or more of the first through seventh aspects, the L1 RSRP or L1 SINR measurement accuracy requirement is based at least in part on a UE capability (e.g., as described in connection with FIG. 5).

In a ninth aspect, alone or in combination with one or more of the first through eighth aspects, process 600 includes transmitting, to the network node, a radio resource control message or user-plane signaling that includes an L1 RSRP or L1 SINR measurement accuracy requirement identifier associated with a measurement accuracy requirement that is based at least in part on the UE capability (e.g., as described in connection with FIG. 5).

In a tenth aspect, alone or in combination with one or more of the first through ninth aspects, the L1 RSRP or L1 SINR measurement accuracy requirement included in the indication from the network node does not exceed the measurement accuracy requirement that is based at least in part on the UE capability (e.g., as described in connection with FIG. 5).

In an eleventh aspect, alone or in combination with one or more of the first through tenth aspects, the L1 RSRP or L1 SINR measurement accuracy associated with the L1 RSRP or L1 SINR reported by the UE satisfies the L1 RSRP or L1 SINR measurement accuracy requirement included in the indication from the network node (e.g., as described in connection with FIG. 5).

In a twelfth aspect, alone or in combination with one or more of the first through eleventh aspects, the L1 RSRP or L1 SINR measurement accuracy associated with the L1 RSRP or L1 SINR reported by the UE does not satisfy the L1 RSRP or L1 SINR measurement accuracy requirement included in the indication from the network node (e.g., as described in connection with FIG. 5).

In a thirteenth aspect, alone or in combination with one or more of the first through twelfth aspects, process 600 includes transmitting, to the network node, an indication that a measurement performed by the UE does not satisfy the L1 RSRP or L1 SINR measurement accuracy requirement (e.g., as described in connection with FIG. 5).

In a fourteenth aspect, alone or in combination with one or more of the first through thirteenth aspects, process 600 includes transmitting, to the network node, an L1 RSRP or L1 SINR measurement accuracy identifier associated with an L1 RSRP or L1 SINR measurement accuracy that is capable of being satisfied (e.g., as described in connection with FIG. 5).

In a fifteenth aspect, alone or in combination with one or more of the first through fourteenth aspects, process 600 includes dropping an L1 RSRP or L1 SINR in accordance with the UE not being able to satisfy the L1 RSRP or L1 SINR measurement accuracy requirement (e.g., as described in connection with FIG. 5).

In a sixteenth aspect, alone or in combination with one or more of the first through fifteenth aspects, process 600 includes transmitting, to the network node, an indication that an L1 RSRP or L1 SINR measurement performed by the UE satisfies the L1 RSRP or L1 SINR measurement accuracy requirement (e.g., as described in connection with FIG. 5).

In a seventeenth aspect, alone or in combination with one or more of the first through sixteenth aspects, transmitting the indication that the L1 RSRP or L1 SINR measurement performed by the UE satisfies the L1 RSRP or L1 SINR measurement accuracy requirement comprises transmitting user-plane signaling, a radio resource control message, a medium access control message, or downlink control information that indicates that the L1 RSRP or L1 SINR measurement performed by the UE satisfies the L1 RSRP or L1 SINR measurement accuracy requirement (e.g., as described in connection with FIG. 5).

In an eighteenth aspect, alone or in combination with one or more of the first through seventeenth aspects, transmitting the indication of the L1 RSRP or L1 SINR measurement accuracy comprises transmitting an indication of an L1 RSRP or L1 SINR measurement accuracy associated with an L1 RSRP or L1 SINR measurement performed by the UE using a model that is trained by the network node (e.g., as described in connection with FIG. 5).

In a nineteenth aspect, alone or in combination with one or more of the first through eighteenth aspects, process 600 includes receiving, from the network node, an indication for the UE to use the model to predict one or more beam characteristics, wherein an input to the model includes an L1 RSRP or L1 SINR that is measured by the UE from a synchronization signal block or a channel state information reference signal (e.g., as described in connection with FIG. 5).

In a twentieth aspect, alone or in combination with one or more of the first through nineteenth aspects, the L1 RSRP or L1 SINR measurement accuracy associated with the L1 RSRP or L1 SINR measurement performed by the UE using the model satisfies an L1 RSRP or L1 SINR measurement accuracy requirement associated with the model (e.g., as described in connection with FIG. 5).

In a twenty-first aspect, alone or in combination with one or more of the first through twentieth aspects, process 600 includes transmitting, to the network node, an indication that the L1 RSRP or L1 SINR measurement performed by the UE using the model does not satisfy an L1 RSRP or L1 SINR measurement accuracy requirement associated with the model (e.g., as described in connection with FIG. 5).

In a twenty-second aspect, alone or in combination with one or more of the first through twenty-first aspects, the L1 RSRP or L1 SINR measurement accuracy requirement is based at least in part on a power-saving mode associated with the UE (e.g., as described in connection with FIG. 5).

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with measurement accuracy reporting.

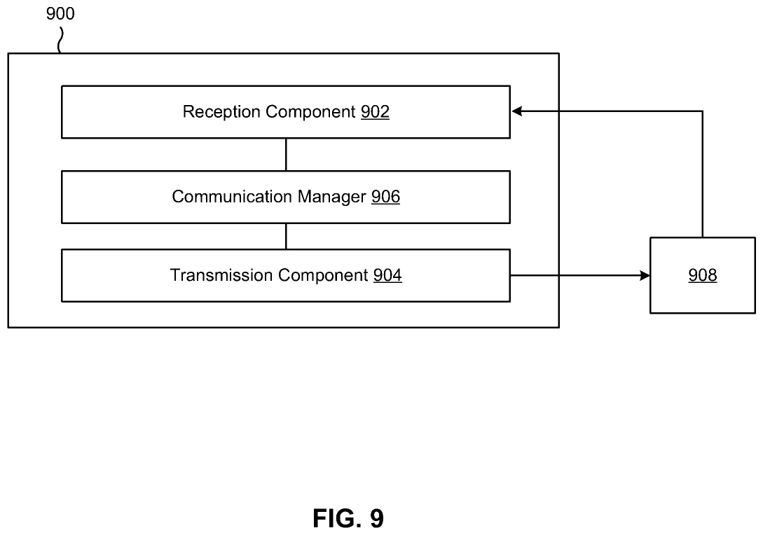

As shown in FIG. 7, in some aspects, process 700 may include transmitting, to a UE, an indication of an L1 RSRP or an L1 SINR measurement accuracy requirement (block 710). For example, the network node (e.g., using transmission component 904 and/or communication manager 906, depicted in FIG. 9) may transmit, to a UE, an indication of an L1 RSRP or an L1 SINR measurement accuracy requirement, as described above. In some aspects, the network node may transmit the indication of the L1 RSRP or the L1 SINR measurement accuracy requirement in a similar manner as described in connection with reference number 505 shown in FIG. 5.

As further shown in FIG. 7, in some aspects, process 700 may include receiving, from the UE, an indication of an L1 RSRP or L1 SINR measurement accuracy associated with an L1 RSRP or L1 SINR reported by the UE (block 720). For example, the network node (e.g., using reception component 902 and/or communication manager 906, depicted in FIG. 9) may receive, from the UE, an indication of an L1 RSRP or L1 SINR measurement accuracy associated with an L1 RSRP or L1 SINR reported by the UE, as described above. In some aspects, the network node may receive the indication of the L1 RSRP or the L1 SINR measurement accuracy in a similar manner as described in connection with reference number 510 shown in FIG. 5.

Process 700 may include additional aspects, such as any single aspect or any combination of aspects described below and/or in connection with one or more other processes described elsewhere herein.

In a first aspect, the L1 RSRP or L1 SINR measurement accuracy requirement is based at least in part on the L1 RSRP or L1 SINR measurement accuracy indication received from the UE (e.g., as described in connection with FIG. 5).

In a second aspect, alone or in combination with the first aspect, the L1 RSRP or L1 SINR measurement accuracy indication received from the UE is based at least in part on the L1 RSRP or L1 SINR measurement accuracy requirement (e.g., as described in connection with FIG. 5).

In a third aspect, alone or in combination with one or more of the first and second aspects, the L1 RSRP or L1 SINR measurement accuracy requirement is associated with an L1 RSRP or L1 SINR to be reported by the UE via an L1 report or a higher-layer protocol message, and receiving the indication of the L1 RSRP or L1 SINR measurement accuracy comprises receiving an L1 report or a higher-layer protocol message that includes the indication of the L1 RSRP or L1 SINR measurement accuracy (e.g., as described in connection with FIG. 5).

In a fourth aspect, alone or in combination with one or more of the first through third aspects, the L1 RSRP or L1 SINR measurement accuracy requirement is based at least in part on an absolute accuracy or a relative accuracy associated with an L1 RSRP or L1 SINR to be reported by the UE, and the L1 RSRP or L1 SINR measurement accuracy associated with the L1 RSRP or L1 SINR reported by the UE is based at least in part on the absolute accuracy or the relative accuracy associated with the L1 RSRP or L1 SINR reported by the UE (e.g., as described in connection with FIG. 5).

In a fifth aspect, alone or in combination with one or more of the first through fourth aspects, a plurality of absolute accuracies or relative accuracies are identified for one or more respective L1 RSRP measurements, L1 SINR measurements, synchronization signal blocks, or channel state information reference signals (e.g., as described in connection with FIG. 5).

In a sixth aspect, alone or in combination with one or more of the first through fifth aspects, process 700 includes identifying a plurality of L1 RSRP or L1 SINR measurement accuracy requirements, wherein the L1 RSRP or L1 SINR measurement accuracy requirement is a select L1 RSRP or L1 SINR measurement accuracy requirement of the plurality of L1 RSRP or L1 SINR measurement accuracy requirements (e.g., as described in connection with FIG. 5).

In a seventh aspect, alone or in combination with one or more of the first through sixth aspects, process 700 includes transmitting, to the UE, user-plane signaling, a radio resource control message, a medium access control message, or downlink control information that indicates the plurality of L1 RSRP or L1 SINR measurement accuracy requirements or an identifier associated with the select L1 RSRP or L1 SINR measurement accuracy requirement (e.g., as described in connection with FIG. 5).

In an eighth aspect, alone or in combination with one or more of the first through seventh aspects, the L1 RSRP or L1 SINR measurement accuracy requirement is based at least in part on a UE capability (e.g., as described in connection with FIG. 5).

In a ninth aspect, alone or in combination with one or more of the first through eighth aspects, process 700 includes receiving, from the UE, a radio resource control message or user-plane signaling that includes an L1 RSRP or L1 SINR measurement accuracy requirement identifier associated with a measurement accuracy requirement that is based at least in part on the UE capability (e.g., as described in connection with FIG. 5).

In a tenth aspect, alone or in combination with one or more of the first through ninth aspects, the L1 RSRP or L1 SINR measurement accuracy requirement included in the indication from the network node does not exceed the measurement accuracy requirement that is based at least in part on the UE capability (e.g., as described in connection with FIG. 5).

In an eleventh aspect, alone or in combination with one or more of the first through tenth aspects, the L1 RSRP or L1 SINR measurement accuracy associated with the L1 RSRP or L1 SINR reported by the UE satisfies the L1 RSRP or L1 SINR measurement accuracy requirement included in the indication from the network node (e.g., as described in connection with FIG. 5).

In a twelfth aspect, alone or in combination with one or more of the first through eleventh aspects, the L1 RSRP or L1 SINR measurement accuracy associated with the L1 RSRP or L1 SINR reported by the UE does not satisfy the L1 RSRP or L1 SINR measurement accuracy requirement included in the indication from the network node (e.g., as described in connection with FIG. 5).

In a thirteenth aspect, alone or in combination with one or more of the first through twelfth aspects, process 700 includes receiving, from the UE, an indication that a measurement performed by the UE does not satisfy the L1 RSRP or L1 SINR measurement accuracy requirement (e.g., as described in connection with FIG. 5).

In a fourteenth aspect, alone or in combination with one or more of the first through thirteenth aspects, process 700 includes receiving, from the UE, an L1 RSRP or L1 SINR measurement accuracy identifier associated with an L1 RSRP or L1 SINR measurement accuracy that is capable of being satisfied (e.g., as described in connection with FIG. 5).

In a fifteenth aspect, alone or in combination with one or more of the first through fourteenth aspects, process 700 includes receiving, from the UE, an indication that an L1 RSRP or L1 SINR measurement performed by the UE satisfies the L1 RSRP or L1 SINR measurement accuracy requirement (e.g., as described in connection with FIG. 5).

In a sixteenth aspect, alone or in combination with one or more of the first through fifteenth aspects, receiving the indication that the L1 RSRP or L1 SINR measurement performed by the UE satisfies the L1 RSRP or L1 SINR measurement accuracy requirement comprises receiving user-plane signaling, a radio resource control message, a medium access control message, or downlink control information that indicates that the L1 RSRP or L1 SINR measurement performed by the UE satisfies the L1 RSRP or L1 SINR measurement accuracy requirement (e.g., as described in connection with FIG. 5).

In a seventeenth aspect, alone or in combination with one or more of the first through sixteenth aspects, receiving the indication of the L1 RSRP or L1 SINR measurement accuracy comprises receiving an indication of an L1 RSRP or L1 SINR measurement accuracy associated with an L1 RSRP or L1 SINR measurement performed by the UE using a model that is trained by the network node (e.g., as described in connection with FIG. 5).

In an eighteenth aspect, alone or in combination with one or more of the first through seventeenth aspects, process 700 includes transmitting, to the UE, an indication for the UE to use the model to predict one or more beam characteristics, wherein an input to the model includes an L1 RSRP or L1 SINR that is measured from a synchronization signal block or a channel state information reference signal (e.g., as described in connection with FIG. 5).

In a nineteenth aspect, alone or in combination with one or more of the first through eighteenth aspects, the L1 RSRP or L1 SINR measurement accuracy associated with the L1 RSRP or L1 SINR measurement performed by the UE using the model satisfies an L1 RSRP or L1 SINR measurement accuracy requirement associated with the model (e.g., as described in connection with FIG. 5).

In a twentieth aspect, alone or in combination with one or more of the first through nineteenth aspects, process 700 includes receiving, from the UE, an indication that the L1 RSRP or L1 SINR measurement performed by the UE using the model does not satisfy an L1 RSRP or L1 SINR measurement accuracy requirement associated with the model (e.g., as described in connection with FIG. 5).

In a twenty-first aspect, alone or in combination with one or more of the first through twentieth aspects, the L1 RSRP or L1 SINR measurement accuracy requirement is based at least in part on a power-saving mode associated with the UE (e.g., as described in connection with FIG. 5).

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, from a network node, an indication of an L1 RSRP or an L1 SINR measurement accuracy requirement. The transmission component 804 may transmit, to the network node, an indication of an L1 RSRP or L1 SINR measurement accuracy associated with an L1 RSRP or L1 SINR reported by the UE.

The communication manager 806 may identify a plurality of L1 RSRP or L1 SINR measurement accuracy requirements, wherein the L1 RSRP or L1 SINR measurement accuracy requirement is a select L1 RSRP or L1 SINR measurement accuracy requirement of the plurality of L1 RSRP or L1 SINR measurement accuracy requirements. The reception component 802 may receive, from the network node, user-plane signaling, a radio resource control message, a medium access control message, or downlink control information that indicates the plurality of L1 RSRP or L1 SINR measurement accuracy requirements or an identifier associated with the select L1 RSRP or L1 SINR measurement accuracy requirement. The transmission component 804 may transmit, to the network node, a radio resource control message or user-plane signaling that includes an L1 RSRP or L1 SINR measurement accuracy requirement identifier associated with a measurement accuracy requirement that is based at least in part on the UE capability. The transmission component 804 may transmit, to the network node, an indication that a measurement performed by the UE does not satisfy the L1 RSRP or L1 SINR measurement accuracy requirement. The transmission component 804 may transmit, to the network node, an L1 RSRP or L1 SINR measurement accuracy identifier associated with an L1 RSRP or L1 SINR measurement accuracy that is capable of being satisfied. The communication manager 806 may drop an L1 RSRP or L1 SINR in accordance with the UE not being able to satisfy the L1 RSRP or L1 SINR measurement accuracy requirement. The transmission component 804 may transmit, to the network node, an indication that an L1 RSRP or L1 SINR measurement performed by the UE satisfies the L1 RSRP or L1 SINR measurement accuracy requirement. The reception component 802 may receive, from the network node, an indication for the UE to use the model to predict one or more beam characteristics, wherein an input to the model includes an L1 RSRP or L1 SINR that is measured by the UE from a synchronization signal block or a channel state information reference signal. The transmission component 804 may transmit, to the network node, an indication that the L1 RSRP or L1 SINR measurement performed by the UE using the model does not satisfy an L1 RSRP or L1 SINR measurement accuracy requirement associated with the model.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a UE, an indication of an L1 RSRP or an L1 SINR measurement accuracy requirement. The reception component 902 may receive, from the UE, an indication of an L1 RSRP or L1 SINR measurement accuracy associated with an L1 RSRP or L1 SINR reported by the UE.

The communication manager 906 may identify a plurality of L1 RSRP or L1 SINR measurement accuracy requirements, wherein the L1 RSRP or L1 SINR measurement accuracy requirement is a select L1 RSRP or L1 SINR measurement accuracy requirement of the plurality of L1 RSRP or L1 SINR measurement accuracy requirements. The transmission component 904 may transmit, to the UE, user-plane signaling, a radio resource control message, a medium access control message, or downlink control information that indicates the plurality of L1 RSRP or L1 SINR measurement accuracy requirements or an identifier associated with the select L1 RSRP or L1 SINR measurement accuracy requirement. The reception component 902 may receive, from the UE, a radio resource control message or user-plane signaling that includes an L1 RSRP or L1 SINR measurement accuracy requirement identifier associated with a measurement accuracy requirement that is based at least in part on the UE capability. The reception component 902 may receive, from the UE, an indication that a measurement performed by the UE does not satisfy the L1 RSRP or L1 SINR measurement accuracy requirement. The reception component 902 may receive, from the UE, an L1 RSRP or L1 SINR measurement accuracy identifier associated with an L1 RSRP or L1 SINR measurement accuracy that is capable of being satisfied. The reception component 902 may receive, from the UE, an indication that an L1 RSRP or L1 SINR measurement performed by the UE satisfies the L1 RSRP or L1 SINR measurement accuracy requirement. The transmission component 904 may transmit, to the UE, an indication for the UE to use the model to predict one or more beam characteristics, wherein an input to the model includes an L1 RSRP or L1 SINR that is measured from a synchronization signal block or a channel state information reference signal. The reception component 902 may receive, from the UE, an indication that the L1 RSRP or L1 SINR measurement performed by the UE using the model does not satisfy an L1 RSRP or L1 SINR measurement accuracy requirement associated with the model.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving, from a network node, an indication of a Layer 1 (L1) reference signal received power (RSRP) or an L1 signal-to-interference-plus-noise ratio (SINR) measurement accuracy requirement; and transmitting, to the network node, an indication of an L1 RSRP or L1 SINR measurement accuracy associated with an L1 RSRP or L1 SINR reported by the UE.
Aspect 2: The method of Aspect 1, wherein the L1 RSRP or L1 SINR measurement accuracy requirement is based at least in part on the L1 RSRP or L1 SINR measurement accuracy indication transmitted by the UE.
Aspect 3: The method of any of Aspects 1-2, wherein the L1 RSRP or L1 SINR measurement accuracy indication transmitted by the UE is based at least in part on the L1 RSRP or L1 SINR measurement accuracy requirement.
Aspect 4: The method of any of Aspects 1-3, wherein the L1 RSRP or L1 SINR measurement accuracy requirement is associated with an L1 RSRP or L1 SINR to be reported by the UE via an L1 report or a higher-layer protocol message, and wherein transmitting the indication of the L1 RSRP or L1 SINR measurement accuracy comprises transmitting an L1 report or a higher-layer protocol message that includes the indication of the L1 RSRP or L1 SINR measurement accuracy.
Aspect 5: The method of any of Aspects 1-4, wherein the L1 RSRP or L1 SINR measurement accuracy requirement is based at least in part on an absolute accuracy or a relative accuracy associated with an L1 RSRP or L1 SINR to be reported by the UE, and wherein the L1 RSRP or L1 SINR measurement accuracy associated with the L1 RSRP or L1 SINR reported by the UE is based at least in part on the absolute accuracy or the relative accuracy associated with the L1 RSRP or L1 SINR reported by the UE.
Aspect 6: The method of Aspect 5, wherein a plurality of absolute accuracies or relative accuracies are identified for one or more respective L1 RSRP measurements, L1 SINR measurements, synchronization signal blocks, or channel state information reference signals.
Aspect 7: The method of any of Aspects 1-6, further comprising identifying a plurality of L1 RSRP or L1 SINR measurement accuracy requirements, wherein the L1 RSRP or L1 SINR measurement accuracy requirement is a select L1 RSRP or L1 SINR measurement accuracy requirement of the plurality of L1 RSRP or L1 SINR measurement accuracy requirements.
Aspect 8: The method of Aspect 7, further comprising receiving, from the network node, user-plane signaling, a radio resource control message, a medium access control message, or downlink control information that indicates the plurality of L1 RSRP or L1 SINR measurement accuracy requirements or an identifier associated with the select L1 RSRP or L1 SINR measurement accuracy requirement.
Aspect 9: The method of any of Aspects 1-8, wherein the L1 RSRP or L1 SINR measurement accuracy requirement is based at least in part on a UE capability.
Aspect 10: The method of Aspect 9, further comprising transmitting, to the network node, a radio resource control message or user-plane signaling that includes an L1 RSRP or L1 SINR measurement accuracy requirement identifier associated with a measurement accuracy requirement that is based at least in part on the UE capability.
Aspect 11: The method of Aspect 10, wherein the L1 RSRP or L1 SINR measurement accuracy requirement included in the indication from the network node does not exceed the measurement accuracy requirement that is based at least in part on the UE capability.
Aspect 12: The method of any of Aspects 1-11, wherein the L1 RSRP or L1 SINR measurement accuracy associated with the L1 RSRP or L1 SINR reported by the UE satisfies the L1 RSRP or L1 SINR measurement accuracy requirement included in the indication from the network node.
Aspect 13: The method of any of Aspects 1-12, wherein the L1 RSRP or L1 SINR measurement accuracy associated with the L1 RSRP or L1 SINR reported by the UE does not satisfy the L1 RSRP or L1 SINR measurement accuracy requirement included in the indication from the network node.
Aspect 14: The method of Aspect 13, further comprising transmitting, to the network node, an indication that a measurement performed by the UE does not satisfy the L1 RSRP or L1 SINR measurement accuracy requirement.
Aspect 15: The method of Aspect 13, further comprising transmitting, to the network node, an L1 RSRP or L1 SINR measurement accuracy identifier associated with an L1 RSRP or L1 SINR measurement accuracy that is capable of being satisfied.
Aspect 16: The method of Aspect 13, further comprising dropping an L1 RSRP or L1 SINR in accordance with the UE not being able to satisfy the L1 RSRP or L1 SINR measurement accuracy requirement.
Aspect 17: The method of any of Aspects 1-16, further comprising transmitting, to the network node, an indication that an L1 RSRP or L1 SINR measurement performed by the UE satisfies the L1 RSRP or L1 SINR measurement accuracy requirement.
Aspect 18: The method of Aspect 17, wherein transmitting the indication that the L1 RSRP or L1 SINR measurement performed by the UE satisfies the L1 RSRP or L1 SINR measurement accuracy requirement comprises transmitting user-plane signaling, a radio resource control message, a medium access control message, or downlink control information that indicates that the L1 RSRP or L1 SINR measurement performed by the UE satisfies the L1 RSRP or L1 SINR measurement accuracy requirement.
Aspect 19: The method of any of Aspects 1-18, wherein transmitting the indication of the L1 RSRP or L1 SINR measurement accuracy comprises transmitting an indication of an L1 RSRP or L1 SINR measurement accuracy associated with an L1 RSRP or L1 SINR measurement performed by the UE using a model that is trained by the network node.
Aspect 20: The method of Aspect 19, further comprising receiving, from the network node, an indication for the UE to use the model to predict one or more beam characteristics, wherein an input to the model includes an L1 RSRP or L1 SINR that is measured by the UE from a synchronization signal block or a channel state information reference signal.
Aspect 21: The method of Aspect 19, wherein the L1 RSRP or L1 SINR measurement accuracy associated with the L1 RSRP or L1 SINR measurement performed by the UE using the model satisfies an L1 RSRP or L1 SINR measurement accuracy requirement associated with the model.
Aspect 22: The method of Aspect 19, further comprising transmitting, to the network node, an indication that the L1 RSRP or L1 SINR measurement performed by the UE using the model does not satisfy an L1 RSRP or L1 SINR measurement accuracy requirement associated with the model.
Aspect 23: The method of any of Aspects 1-22, wherein the L1 RSRP or L1 SINR measurement accuracy requirement is based at least in part on a power-saving mode associated with the UE.
Aspect 24: A method of wireless communication performed by a network node, comprising: transmitting, to a user equipment (UE), an indication of a Layer 1 (L1) reference signal received power (RSRP) or an L1 signal-to-interference-plus-noise ratio (SINR) measurement accuracy requirement; and receiving, from the UE, an indication of an L1 RSRP or L1 SINR measurement accuracy associated with an L1 RSRP or L1 SINR reported by the UE.
Aspect 25: The method of Aspect 24, wherein the L1 RSRP or L1 SINR measurement accuracy requirement is based at least in part on the L1 RSRP or L1 SINR measurement accuracy indication received from the UE.
Aspect 26: The method of any of Aspects 24-25, wherein the L1 RSRP or L1 SINR measurement accuracy indication received from the UE is based at least in part on the L1 RSRP or L1 SINR measurement accuracy requirement.
Aspect 27: The method of Aspect 26, wherein the L1 RSRP or L1 SINR measurement accuracy requirement is associated with an L1 RSRP or L1 SINR to be reported by the UE via an L1 report or a higher-layer protocol message, and wherein receiving the indication of the L1 RSRP or L1 SINR measurement accuracy comprises receiving an L1 report or a higher-layer protocol message that includes the indication of the L1 RSRP or L1 SINR measurement accuracy.
Aspect 28: The method of any of Aspects 24-27, wherein the L1 RSRP or L1 SINR measurement accuracy requirement is based at least in part on an absolute accuracy or a relative accuracy associated with an L1 RSRP or L1 SINR to be reported by the UE, and wherein the L1 RSRP or L1 SINR measurement accuracy associated with the L1 RSRP or L1 SINR reported by the UE is based at least in part on the absolute accuracy or the relative accuracy associated with the L1 RSRP or L1 SINR reported by the UE.
Aspect 29: The method of Aspect 28, wherein a plurality of absolute accuracies or relative accuracies are identified for one or more respective L1 RSRP measurements, L1 SINR measurements, synchronization signal blocks, or channel state information reference signals.
Aspect 30: The method of any of Aspects 24-29, further comprising identifying a plurality of L1 RSRP or L1 SINR measurement accuracy requirements, wherein the L1 RSRP or L1 SINR measurement accuracy requirement is a select L1 RSRP or L1 SINR measurement accuracy requirement of the plurality of L1 RSRP or L1 SINR measurement accuracy requirements.
Aspect 31: The method of Aspect 30, further comprising transmitting, to the UE, user-plane signaling, a radio resource control message, a medium access control message, or downlink control information that indicates the plurality of L1 RSRP or L1 SINR measurement accuracy requirements or an identifier associated with the select L1 RSRP or L1 SINR measurement accuracy requirement.
Aspect 32: The method of any of Aspects 24-31, wherein the L1 RSRP or L1 SINR measurement accuracy requirement is based at least in part on a UE capability.
Aspect 33: The method of Aspect 32, further comprising receiving, from the UE, a radio resource control message or user-plane signaling that includes an L1 RSRP or L1 SINR measurement accuracy requirement identifier associated with a measurement accuracy requirement that is based at least in part on the UE capability.
Aspect 34: The method of Aspect 33, wherein the L1 RSRP or L1 SINR measurement accuracy requirement included in the indication from the network node does not exceed the measurement accuracy requirement that is based at least in part on the UE capability.
Aspect 35: The method of any of Aspects 24-34, wherein the L1 RSRP or L1 SINR measurement accuracy associated with the L1 RSRP or L1 SINR reported by the UE satisfies the L1 RSRP or L1 SINR measurement accuracy requirement included in the indication from the network node.
Aspect 36: The method of any of Aspects 24-35, wherein the L1 RSRP or L1 SINR measurement accuracy associated with the L1 RSRP or L1 SINR reported by the UE does not satisfy the L1 RSRP or L1 SINR measurement accuracy requirement included in the indication from the network node.
Aspect 37: The method of Aspect 36, further comprising receiving, from the UE, an indication that a measurement performed by the UE does not satisfy the L1 RSRP or L1 SINR measurement accuracy requirement.
Aspect 38: The method of Aspect 36, further comprising receiving, from the UE, an L1 RSRP or L1 SINR measurement accuracy identifier associated with an L1 RSRP or L1 SINR measurement accuracy that is capable of being satisfied.
Aspect 39: The method of any of Aspects 24-38, further comprising receiving, from the UE, an indication that an L1 RSRP or L1 SINR measurement performed by the UE satisfies the L1 RSRP or L1 SINR measurement accuracy requirement.
Aspect 40: The method of Aspect 39, wherein receiving the indication that the L1 RSRP or L1 SINR measurement performed by the UE satisfies the L1 RSRP or L1 SINR measurement accuracy requirement comprises receiving user-plane signaling, a radio resource control message, a medium access control message, or downlink control information that indicates that the L1 RSRP or L1 SINR measurement performed by the UE satisfies the L1 RSRP or L1 SINR measurement accuracy requirement.
Aspect 41: The method of any of Aspects 24-40, wherein receiving the indication of the L1 RSRP or L1 SINR measurement accuracy comprises receiving an indication of an L1 RSRP or L1 SINR measurement accuracy associated with an L1 RSRP or L1 SINR measurement performed by the UE using a model that is trained by the network node.
Aspect 42: The method of Aspect 41, further comprising transmitting, to the UE, an indication for the UE to use the model to predict one or more beam characteristics, wherein an input to the model includes an L1 RSRP or L1 SINR that is measured from a synchronization signal block or a channel state information reference signal.
Aspect 43: The method of Aspect 41, wherein the L1 RSRP or L1 SINR measurement accuracy associated with the L1 RSRP or L1 SINR measurement performed by the UE using the model satisfies an L1 RSRP or L1 SINR measurement accuracy requirement associated with the model.
Aspect 44: The method of Aspect 41, further comprising receiving, from the UE, an indication that the L1 RSRP or L1 SINR measurement performed by the UE using the model does not satisfy an L1 RSRP or L1 SINR measurement accuracy requirement associated with the model.
Aspect 45: The method of any of Aspects 24-44, wherein the L1 RSRP or L1 SINR measurement accuracy requirement is based at least in part on a power-saving mode associated with the UE.
Aspect 46: An apparatus for wireless communication at a device, comprising a processor; memory coupled with the processor; and instructions stored in the memory and executable by the processor to cause the apparatus to perform the method of one or more of Aspects 1-45.
Aspect 47: A device for wireless communication, comprising a memory and one or more processors coupled to the memory, the one or more processors configured to perform the method of one or more of Aspects 1-45.
Aspect 48: An apparatus for wireless communication, comprising at least one means for performing the method of one or more of Aspects 1-45.
Aspect 49: A non-transitory computer-readable medium storing code for wireless communication, the code comprising instructions executable by a processor to perform the method of one or more of Aspects 1-45.
Aspect 50: A non-transitory computer-readable medium storing a set of instructions for wireless communication, the set of instructions comprising one or more instructions that, when executed by one or more processors of a device, cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors coupled to the one or more memories, the one or more processors individually or collectively configured to:
receive, from a network node, an indication of a Layer 1 (L1) reference signal received power (RSRP) or an L1 signal-to-interference-plus-noise ratio (SINR) measurement accuracy requirement; and
transmit, to the network node, an indication of an L1 RSRP or L1 SINR measurement accuracy associated with an L1 RSRP or L1 SINR reported by the UE.

2. The UE of claim 1, wherein the L1 RSRP or L1 SINR measurement accuracy requirement is based at least in part on the L1 RSRP or L1 SINR measurement accuracy indication transmitted by the UE.

3. The UE of claim 1, wherein the L1 RSRP or L1 SINR measurement accuracy indication transmitted by the UE is based at least in part on the L1 RSRP or L1 SINR measurement accuracy requirement.

4. The UE of claim 1, wherein the L1 RSRP or L1 SINR measurement accuracy requirement is associated with an L1 RSRP or L1 SINR to be reported by the UE via an L1 report or a higher-layer protocol message, and wherein the one or more processors, to transmit the indication of the L1 RSRP or L1 SINR measurement accuracy, are configured to transmit an L1 report or a higher-layer protocol message that includes the indication of the L1 RSRP or L1 SINR measurement accuracy.

5. The UE of claim 1, wherein the L1 RSRP or L1 SINR measurement accuracy requirement is based at least in part on an absolute accuracy or a relative accuracy associated with an L1 RSRP or L1 SINR to be reported by the UE, and wherein the L1 RSRP or L1 SINR measurement accuracy associated with the L1 RSRP or L1 SINR reported by the UE is based at least in part on the absolute accuracy or the relative accuracy associated with the L1 RSRP or L1 SINR reported by the UE.

6. The UE of claim 5, wherein a plurality of absolute accuracies or relative accuracies are identified for one or more respective L1 RSRP measurements, L1 SINR measurements, synchronization signal blocks, or channel state information reference signals.

7. The UE of claim 1, wherein the one or more processors are further individually or collectively configured to identify a plurality of L1 RSRP or L1 SINR measurement accuracy requirements, wherein the L1 RSRP or L1 SINR measurement accuracy requirement is a select L1 RSRP or L1 SINR measurement accuracy requirement of the plurality of L1 RSRP or L1 SINR measurement accuracy requirements.

8. The UE of claim 7, wherein the one or more processors are further individually or collectively configured to receive, from the network node, user-plane signaling, a radio resource control message, a medium access control message, or downlink control information that indicates the plurality of L1 RSRP or L1 SINR measurement accuracy requirements or an identifier associated with the select L1 RSRP or L1 SINR measurement accuracy requirement.

9. The UE of claim 1, wherein the L1 RSRP or L1 SINR measurement accuracy requirement is based at least in part on a UE capability.

10. The UE of claim 9, wherein the one or more processors are further individually or collectively configured to transmit, to the network node, a radio resource control message or user-plane signaling that includes an L1 RSRP or L1 SINR measurement accuracy requirement identifier associated with a measurement accuracy requirement that is based at least in part on the UE capability.

11. The UE of claim 10, wherein the L1 RSRP or L1 SINR measurement accuracy requirement included in the indication from the network node does not exceed the measurement accuracy requirement that is based at least in part on the UE capability.

12. The UE of claim 1, wherein the L1 RSRP or L1 SINR measurement accuracy associated with the L1 RSRP or L1 SINR reported by the UE satisfies the L1 RSRP or L1 SINR measurement accuracy requirement included in the indication from the network node.

13. The UE of claim 1, wherein the L1 RSRP or L1 SINR measurement accuracy associated with the L1 RSRP or L1 SINR reported by the UE does not satisfy the L1 RSRP or L1 SINR measurement accuracy requirement included in the indication from the network node.

14. The UE of claim 13, wherein the one or more processors are further individually or collectively configured to transmit, to the network node, an indication that a measurement performed by the UE does not satisfy the L1 RSRP or L1 SINR measurement accuracy requirement.

15-23. (canceled)

24. A network node for wireless communication, comprising:
one or more memories; and
one or more processors coupled to the one or more memories, the one or more processors individually or collectively configured to:
transmit, to a user equipment (UE), an indication of a Layer 1 (L1) reference signal received power (RSRP) or an L1 signal-to-interference-plus-noise ratio (SINR) measurement accuracy requirement; and
receive, from the UE, an indication of an L1 RSRP or L1 SINR measurement accuracy associated with an L1 RSRP or L1 SINR reported by the UE.

25. The network node of claim 24, wherein the L1 RSRP or L1 SINR measurement accuracy requirement is based at least in part on the L1 RSRP or L1 SINR measurement accuracy indication received from the UE.

26. The network node of claim 24, wherein the L1 RSRP or L1 SINR measurement accuracy indication received from the UE is based at least in part on the L1 RSRP or L1 SINR measurement accuracy requirement.

27. The network node of claim 26, wherein the L1 RSRP or L1 SINR measurement accuracy requirement is associated with an L1 RSRP or L1 SINR to be reported by the UE via an L1 report or a higher-layer protocol message, and wherein the one or more processors, to receive the indication of the L1 RSRP or L1 SINR measurement accuracy, are configured to receive an L1 report or a higher-layer protocol message that includes the indication of the L1 RSRP or L1 SINR measurement accuracy.

28. The network node of claim 24, wherein the L1 RSRP or L1 SINR measurement accuracy requirement is based at least in part on an absolute accuracy or a relative accuracy associated with an L1 RSRP or L1 SINR to be reported by the UE, and wherein the L1 RSRP or L1 SINR measurement accuracy associated with the L1 RSRP or L1 SINR reported by the UE is based at least in part on the absolute accuracy or the relative accuracy associated with the L1 RSRP or L1 SINR reported by the UE.

29. A method of wireless communication performed by a user equipment (UE), comprising:
receiving, from a network node, an indication of a Layer 1 (L1) reference signal received power (RSRP) or an L1 signal-to-interference-plus-noise ratio (SINR) measurement accuracy requirement; and
transmitting, to the network node, an indication of an L1 RSRP or L1 SINR measurement accuracy associated with an L1 RSRP or L1 SINR reported by the UE.

30. (canceled)
